(19) United States
(12) Patent Application Publication
(10) Pub. No.: US 2004/0065627 A1
(43) Pub. Date: Apr. 8, 2004

(54) Precoat filter cartridge, precoat cartridge filter and use of a filter cartridge

(75) Inventor: Werner Loser, Oberuzwil (CH)

Correspondence Address: SHOEMAKER AND MATTARE, LTD, P.O. BOX 2286, 2001 JEFFERSON DAVIS HIGHWAY, ARLINGTON, VA, 22202-0286, US

(73) Assignee: Filtrox AG, St. Gallen (CH)

(21) Appl. No.: 10/614,692

(22) Filed: Jul. 8, 2003

(30) Foreign Application Priority Data
Jul. 8, 2002 (EP) 02015171.8

(51) Int. Cl. B01D 29/48

(52) U.S. Cl. 210/777; 210/323.2; 210/497.1

(57) ABSTRACT

The performance of a precoat cartridge filter is increased considerably, compared with conventional precoat filter cartridges, by reducing the outer diameter of the precoat filter cartridge. The cross-sectional area of the internal space defined by the precoat filter cartridges is reduced as compared with the cross-sectional area of the unfiltrate space. As a result, phase mixing at a phase change is likewise reduced.

### BACKGROUND OF THE INVENTION

The invention relates to a precoat filter cartridge, a precoat cartridge filter and the use of a filter cartridge.

For the filtration of liquids, in particular beer or wine, it is known to use precoat filters, as they are called. Here, use is made of a filter aid which is added to the liquid to be filtered or previously precoated and which is precoated against a filter surface. As the liquid to be filtered passes through the precoated layer of filter aids, the liquid is filtered.

What are known as horizontal filters and cartridge filters are known for precoat filtration. In the case of horizontal filters, a plurality of filter discs are arranged one above another on a shaft in a filter vessel. The layer of filter aid is deposited on the upper side of these discs. As the liquid passes through the filter layer, typically a layer of kieselguhr, filtration takes place. The liquid filtered as a result passes into the interior of the discs and is led away from the interior of the discs through a central line.

In the case of what are known as cartridge filters, a dividing wall is provided in a filter vessel and divides the filter vessel into an unfiltrate and a filtrate space. Fixed to the dividing wall are filter cartridges, which extend into the unfiltrate space. The filter cartridges have a surface provided with openings. For example, EP 203 206 discloses the use of filter cartridges with a wire which is wound helically onto wire rods. A thin gap formed between the turns of wire permits the passage of liquid from the outer side of the filter cartridge, on which the precoat layer is deposited, into the interior of the cartridge. The liquid is led from the interior of the filter cartridge through an opening in the dividing plate into the filtrate space and can be carried away from there as filtrate.

Such precoat cartridge filters have been tried and tested and have been widely accepted. There is a need to change over existing horizontal filters as well to form cartridge filters. In this case, it would be possible to fall back on existing filter vessels. It would merely be necessary to remove the filter discs from the vessel, to insert a horizontal dividing plate and to fix an appropriate number of filter cartridges thereto. One problem in the case of such known filter cartridges, however, is that the filter performance which can be achieved with these cartridges at the same vessel volume is lower than the performance achieved with the horizontal filters.

In addition, in the case of cartridge filters, there is the need to achieve the highest possible filtration performances with the lowest possible content of the filter vessel.

### SUMMARY OF THE INVENTION

It is therefore the object of the present invention to avoid the disadvantages of what is known, in particular therefore to provide a filter cartridge which is also suitable for changing horizontal filter systems into cartridge filters. In the event of such a changeover, the filter performance of the cartridge filter should be approximately comparable to the filter performance of the horizontal filter. A further object of the invention is to provide a filter cartridge with which the performance of a precoat cartridge filter may be increased, based on the volume of the filter vessel.

During precoat filtration it is necessary to backwash the filter arrangement from time to time, in order to remove the layer of filter aids loaded with turbid materials from the surface of the filter cartridges. In the process, it should be ensured that the precoat layer is removed as completely as possible and that the water used for the backwashing is removed as quickly and completely as possible from the surface of the cartridge again. A further object of the present invention is, therefore, to develop a filter cartridge further in such a way that, during backwashing, the backwashing liquid can be removed as quickly and completely as possible from the surface of the filter cartridge, in particular from its lower terminating piece.

According to the invention, these objects are achieved by a precoat filter cartridge, a precoat cartridge filter and the use of a precoat filter cartridge as described below.

The precoat filter cartridge according to the invention is provided, in a manner known per se, with a plurality of supporting rods. A top piece for fixing the cartridge to a dividing wall or perforated plate of a cartridge filter is connected to one end of the supporting rods. A terminating piece for dividing off the internal space of the filter cartridge from the unfiltrate space is connected to the other end of the supporting rods. A wire is wound helically onto the supporting rods. A gap for the passage of liquids is formed between adjacent turns of wire. The wire forms a cartridge wall, which forms a substrate for a precoat filter layer.

According to the invention, the filter cartridge has an outer diameter which is less than 30 cm. According to a preferred embodiment, the outer diameter of the precoat filter cartridge is between 20 and 28 cm. An outer diameter of about 25 cm is particularly preferred.

Conventionally employed filter cartridges have relatively large diameters. Typically, hitherto cartridges with diameters of 32.5 cm or even much larger cartridges have been employed. By means of the specific reduction in the diameter of the filter cartridge, various advantages can be achieved.

The filter surface available and, as a result, the filter performance in a vessel with a predefined content can be increased considerably. Since the filter cartridges are smaller, a larger number of cartridges can be inserted into the unfiltrate space of a filter vessel. Thanks to the reduction in the outer diameter, changing horizontal filter systems over to precoat cartridge filters therefore becomes possible, so that the performance of the changed-over filter is approximately identical to the performance of the horizontal filter.

A further advantage of the invention is that the volume of the filtrate in the interior of the filter cartridges is reduced. On account of the reduction in the filtrate volume, the quantity of mixed filtrate at what are known as phase changes can be reduced. If different liquids are to be filtered in a filter system, then at the time of the change in the liquid to the filtered, that is to say at what is known as a phase change, there is always a certain amount of mixing of the first with the second liquid. This mixed liquid is lost in the process. As a result of the reduction in the cartridge diameter, the filtrate space in the interior of the cartridges can be reduced, so that the volume of the mixed liquid at a phase change is also reduced.

A further advantage of the invention is that the thickness of the precoat filter layer becomes smaller with the same sludge volume. As a result, the filtration performance may be increased. Given a predefined sludge volume, more filter area is available in the case of filter systems equipped with cartridges according to the invention. As a result, the thickness of the precoat layer is automatically reduced.

A further advantage of the invention is that the edge zones of filter systems equipped according to the invention can be utilized better. Filter vessels are generally of cylindrical construction. By virtue of selecting smaller filter cartridges, the internal space of the filter vessel can be packed more compactly, in particular also filled in the edge region.

According to a preferred embodiment of the invention, as compared with conventional filter cartridges, the number of supporting rods is also reduced. Typically, conventional filter cartridges have eight or more supporting rods. The filter cartridge according to the invention uses, for example, six supporting rods. As a result of the smaller number of supporting rods, the number of welded joints between the supporting rods and the wire wound on is reduced, which leads to a reduction in the production costs. From a hygienic point of view, too, a reduction in the supporting rods is advantageous, since the connection points, which are difficult to clean, between the supporting rods and the wire wound on are reduced to a minimum.

According to a further preferred embodiment, on their side oriented radially inwards, the supporting rods have a cross-sectional taper, for example a rounded portion. Such filter cartridges with a wire wound on are produced automatically. For this purpose, the supporting rods are held on a rotatable mandrel. The wire is wound on spirally and in each case welded to the supporting rods at the point of intersection. On account of the arrangement of the mandrel and the dimension of the supporting rods, the filter cartridge cannot be made arbitrarily small, otherwise, there would be the risk that the supporting rods would touch at the center of the mandrel, or the depressions for holding the supporting rods would weaken the mandrel too much. By virtue of the taper at the end oriented radially inwards, it is possible to reduce the radius of the filter cartridge further without there being the risk of the supporting rods touching in the mandrel or without the mandrel being weakened too severely because of the size of the cutouts for the supporting rods.

According to a further preferred embodiment, the terminating piece of the precoat filter cartridge, which divides the interior of the cartridge from the unfiltrate space, is tapered towards its end. Typically, a spherical or else a conical taper is conceivable. With this arrangement, the backwashing behavior of the precoat filter cartridge is improved. In particular, on account of the taper at the lowest point of the terminating piece, the backwashing liquid runs together and is collected there. Individual drops are prevented from remaining on the surface of the terminating piece.

In addition, the form described permits satisfactory deaeration of the filter and prevents gas bubbles remaining on the area of the terminating piece which is oriented downwards and which could have a detrimental effect on the filtration process during the filtration. A further advantage of the tapered design is the reduction in the flow resistance. As a result, fewer vortices are also produced, which can lead to the filter aid being floated off in the lower part of the cartridges.

This embodiment can also be employed in conjunction with conventional precoat filter cartridges with their outer diameters not reduced.

The filtrate is led out of the interior of the filter cartridge through a passage opening in the top piece and into the openings in the perforated plate. It is advantageous if the precoat filter cartridge according to the invention could be used in combination with perforated plates which have the same hole diameters as perforated plates of conventional filter systems. The passage opening in the top piece of the cartridge according to the invention should therefore have the same diameter as the passage opening in conventional cartridges. However, because the outer diameter of the cartridge according to the invention is smaller than in the case of conventional cartridges, the sealing surface with which the top piece rests on the perforated plate is reduced. According to a further preferred embodiment, provision is therefore made to provide the end of the top piece with a conical taper. With a conical sealing surface extending at an angle of 45 degrees, for example, the sealing surface can be enlarged by the factor root two as compared with a horizontal sealing surface.

The precoat cartridge filter according to the invention comprises, in a manner known per se, a filter vessel with a dividing wall. The dividing wall divides the filter vessel into an unfiltrate space and into a filtrate space. A large number of precoat filter cartridges are fixed to the dividing wall and extend into the unfiltrate space.

According to the invention, the precoat filter cartridges used are dimensioned and arranged regularly in such a way that the product of cartridge diameter in millimeters and cartridge spacing between the surfaces of adjacent cartridges in millimeters is less than or equal to 2300 mm². The product forms the optimum of filter area and sludge volume, the cartridge diameter determining the filter area and the cartridge spacing the sludge volume. As a result, the filter area is maximized in relation to the sludge volume and the filter is optimized. With the present invention, unexpectedly, it has been found that the filter performance may be increased considerably by simple measures under predefined boundary conditions, in particular the dimension of the filter vessel and sludge volume. On account of the reduction in the cartridge diameter, and thus the cross section of the cartridge interior, the space formed in the precoat filter cartridges for the filtrate is reduced. In addition, space for a larger number of filter cartridges is created in the filter vessel. It is therefore possible, with the sludge volume kept constant, to increase the filter area, that is to say the total area of the surfaces of the individual cartridges. As a result, the filter performance is increased. At the same time, the layer thickness of the precoat layer is reduced. In addition, the reduction in the volume of the filtrate space in the interior of the cartridges leads to the volume of the mixed phase at phase changes of liquids being reduced.

The product of cartridge diameter and cartridge spacing should at the same time be greater than 1000 mm². An arbitrary reduction is barely possible, for practical reasons, since, in the case of excessively small or excessively close filter cartridges, no acceptable precoat behavior could be achieved.

The total surface of the filter cartridges is preferably more than 10 m² per meter length of the filter cartridges and per m² of cross-sectional area of the unfiltrate space. The total surface of the filter cartridges is preferably more than 15 m². With the arrangement according to the invention, it is therefore possible, given comparable vessel volumes, to achieve filter performances which are about 20% greater.

The filter cartridge described at the beginning may be employed particularly advantageously in such a precoat cartridge filter. In particular, the filter cartridge described at the beginning can, however, also be employed for changing over a conventional horizontal filter system into a precoat cartridge filter system, without significant losses in performance resulting.

### BRIEF DESCRIPTION OF THE DRAWINGS

The invention will be explained in more detail below in exemplary embodiments and by reference to the drawings, in which:

FIG. 1 shows a schematic illustration of a precoat cartridge filter according to the invention,

FIG. 2 shows an illustration of a filter cartridge according to the invention in side view, partly in section,

FIG. 3 shows a cross section of a filter cartridge according to the invention with an enlarged illustration of a supporting rod,

FIG. 4 shows a cross section through the filter vessel of a precoat cartridge filter according to the invention,

FIG. 5a shows a first embodiment of a preferred design of a terminating piece,

FIG. 5b shows a second embodiment of a preferred design of a terminating piece,

FIG. 6 shows a cross section through a top piece of a filter cartridge according to the invention,

FIG. 7 shows an enlarged illustration of a detail from FIG. 4, and

FIG. 8 shows a cross section through a mandrel for producing filter cartridges according to the invention.

### DESCRIPTION OF THE PREFERRED EMBODIMENT(S)

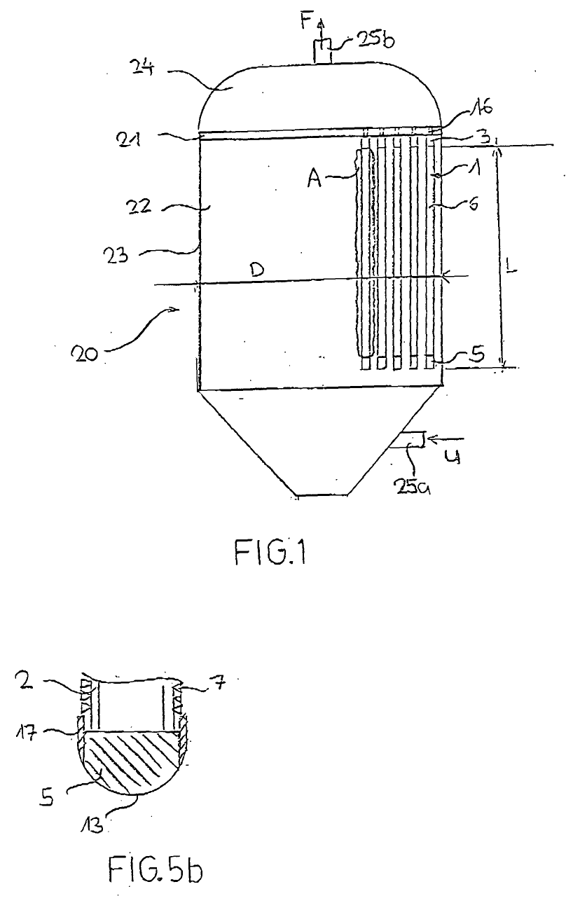

FIG. 1 shows a precoat cartridge filter 20. The precoat cartridge filter 20 has a vessel 23. A dividing wall 21 divides the vessel 23 into an unfiltrate space 22 and into a filtrate space 24. Unfiltered liquid U, the unfiltrate, is led into the unfiltrate space 22 through a connection 25a.

The dividing wall 21, formed as a perforated plate, has openings 16 for the fixing of precoat filter cartridges 1. The precoat filter cartridges 1 are provided, in a manner known per se, with a cartridge wall formed from a slotted tube.

Before filtration, a filter aid is precoated on the filter cartridges in a manner known per se. As a result, a layer A of filter aid is formed on the outside of the cartridges 1. For the purpose of filtration, the unfiltrate U passes through the precoat layer A and, in so doing, passes into the interior 6 of the filter cartridges 1. The interior 6 of the filter cartridges 1 is separated from the unfiltrate space 22 by a terminating piece 5. The liquid filtered because it has passed through the precoat layer A passes through a passage opening in a top piece 3, by which the precoat filter cartridge 1 is fixed to the dividing wall 21, through the openings 16 in the dividing wall 21 and into the filtrate space 24. The filtered liquid leaves the filtrate space 24 as filtrate F through a second connection 25b.

The filter vessel 23 has a clear inner diameter D. The free inner diameter is typically half to two and a half meters, 1112 mm in a practical exemplary embodiment. The filter cartridges 1 have an active length L. The length L designates that part of the filter cartridge in which the cartridge wall is permeable. The length of the filter cartridge can typically be between 50 cm and 3 m. In the practical exemplary embodiment, the length L is, for example, 892 mm.

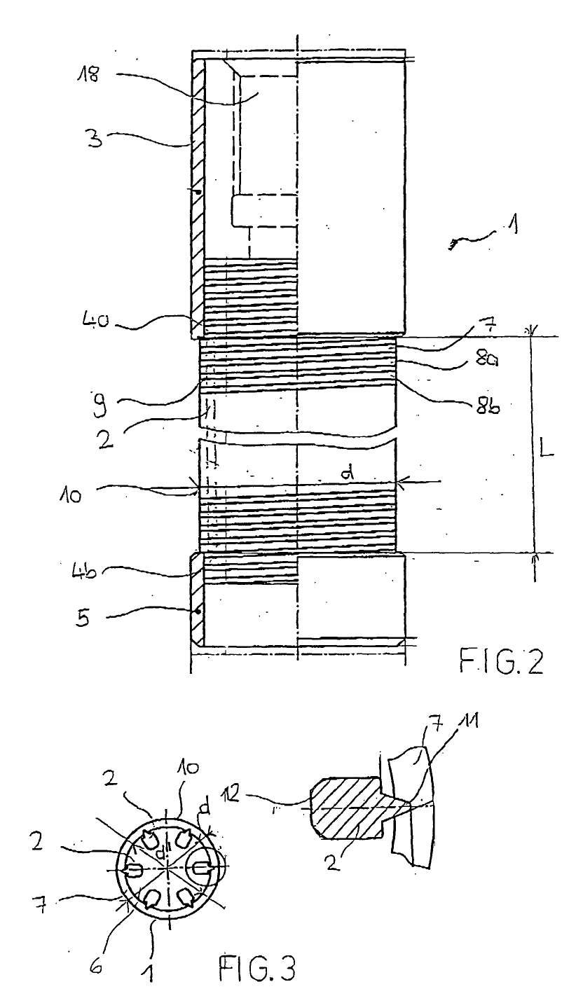

FIG. 2 shows an enlarged illustration of the filter cartridge 1 according to the invention. The filter cartridge 1 has a top piece 3. The top piece 3 is provided with a passage opening 18. Supporting rods 2 are fixed by an upper end 4a to the top piece 3. Fixing is typically carried out by means of welding. The other end 4b of the supporting rods 2 is connected to a terminating piece 5. FIG. 2 shows only one supporting rod 2. Typically, six supporting rods 2 in a symmetrical arrangement are employed (see FIG. 3). A wire 7 is wound helically onto the supporting rods 2. A gap 9 is formed between adjacent turns 8a, 8b of the wire. The gap 9 typically has a gap width of 40 to 100 (m. At each point of intersection between a supporting rod 2 and the wire 7, the wire 7 is welded to the supporting rod 2.

The wire 7 wound on forms a cartridge wall 10, which forms the substrate for the precoat layer A. The filter cartridge 1 has an outer diameter d. According to the invention, the outer diameter d is less than 30 cm. In the practical exemplary embodiment, the outer diameter d is 25 cm.

FIG. 3 shows a cross section through the filter cartridge 1 in a plane at right angles to the axis of the cartridge. The wire 7 wound onto the supporting rods 2 forms a cartridge wall 10 which encloses a cartridge interior 6. The cartridge interior 6 defines a filtrate space for the liquid in the interior of the precoat filter cartridge 1. On one side, the supporting rods 2 have a point 11. The point 11 is used to simplify the welding of the supporting rods 2 to the wire 7. On the other side, that is to say on the radially inner side of the supporting rods 2, the supporting rods have a tapering inner side 12. The inner side 12 has, for example, two rounded portions.

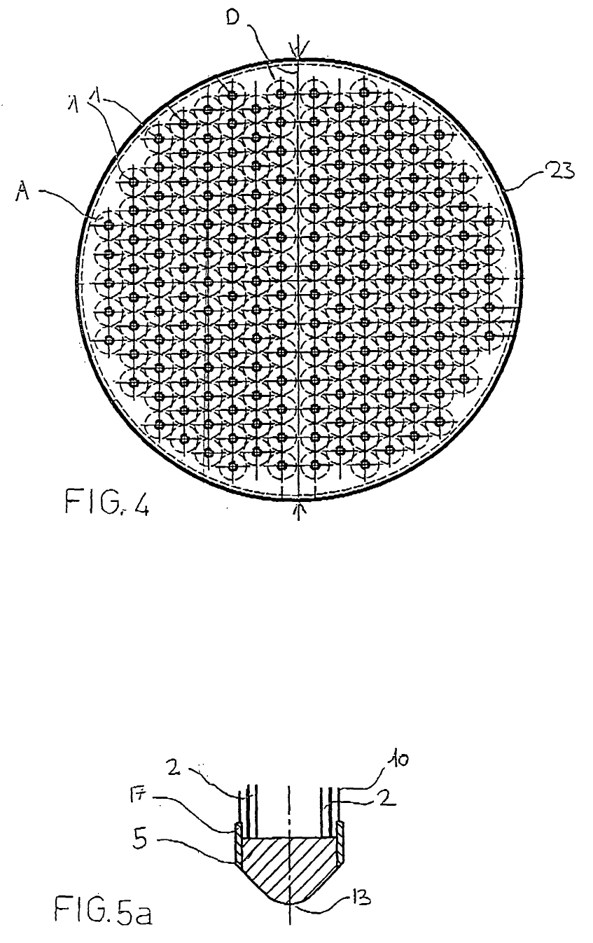

FIG. 4 shows a cross section through the vessel 23 of a precoat cartridge filter according to the invention. The vessel 23 is constructed in a manner known per se and has a free internal diameter D. A large number of filter cartridges 1 is arranged in the vessel 23. In the specific exemplary embodiment, for example, 178 cartridges are arranged in the manner of a honeycomb. As a result, optimum packing of the interior of the vessel 23 can be achieved. According to the invention, the number of filter cartridges and the outer diameter d of the filter cartridges and, respectively, the inner diameter d′ of the filter cartridge 1 (see FIG. 3) are selected such that the product of cartridge diameter d in mm and cartridge spacing a in mm is less than or equal to 2300 mm. The product forms the optimum of filter area and sludge volume, the cartridge diameter determining the filter area and the cartridge spacing the sludge volume. The product of cartridge diameter and cartridge spacing in the specific exemplary embodiment is 1800 mm²(d=25 mm x a=72 mm).

A comparison between the filter cartridges according to the invention with reduced outer diameter d and conventional filter cartridges shows the advantages which can be achieved with the present invention.

Typically, hitherto filter cartridges with an outer diameter of 32.5 mm have been used. In the filter vessel already mentioned, with an inner diameter of 1088 mm, it was possible to use 114 such conventional cartridges. With the same cartridge length, the cartridge surface with filter cartridges according to the invention with reduced outer diameter is increased by about 20%. This is based on the fact that, because of the smaller dimensions, more cartridges can be arranged. As a result, the filter performance can also be increased by more than about 20%, without the dimension of the filter system having to be enlarged. Typically, with the arrangement described according to the invention, virtually 95 hectoliters per hour of beer may be filtered. Using conventional filter cartridges, however, only 77 hectoliters of beer per hour could be filtered.

With the cartridge according to the invention, the thickness of the precoat layer A and of the filter cake which is formed is likewise reduced. The maximum diameter of the filter cake in the case of cartridges according to the invention in the arrangement described above is 70 mm. The maximum cake thickness is therefore 22.5 mm. In the case of conventional cartridges as described above, the maximum cake diameter is 87 mm and the cake thickness 27.25 mm. As a result, the spacing between cartridges of 89 mm in the case of conventional cartridges can be reduced to 72 mm in the specific exemplary embodiment according to the invention. In each case a safety margin of 2 mm is left between adjacent cartridges or the precoat layers. Because the cartridge spacing between individual precoat filter cartridges 1 according to the invention can be reduced, more cartridges can be provided per square meter cross-sectional area of the unfiltrate space. As a result, the filter area as a whole can be increased.

In addition, the filtrate volume of the cartridge assembly with the precoat filter cartridge according to the invention can be reduced. The total volume of all the cartridges according to the described exemplary embodiment according to the invention is 52 liters as compared with 62 liters in the exemplary embodiment as described above having conventional filter cartridges. As a result, the filtrate volume is reduced by 16%. Even if the volume of 178 liters in the filtrate space 24 according to one exemplary embodiment is taken into account, the result is still a reduction of 4% in the total filtrate volume.

FIG. 5a shows a first exemplary embodiment of a terminating piece 5. The terminating piece 5 has a taper at its lower end 13. The taper is typically conical. The lower end is rounded off slightly. This means that, during the backwashing process, backwashing liquid flows along the tapering surface towards the tip at the end 13 of the terminating piece 5 and drips off from there. The terminating piece 5 is provided with a sleeve 17 which covers the bottom end of the cartridge wall 10. An alternative exemplary embodiment is shown in FIG. 5b. In the example according to FIG. 5b, the lower end 13 of the terminating piece 15 is hemispherical. Otherwise, the exemplary embodiment according to FIG. 5b is identical to the example according to FIG. 5a.

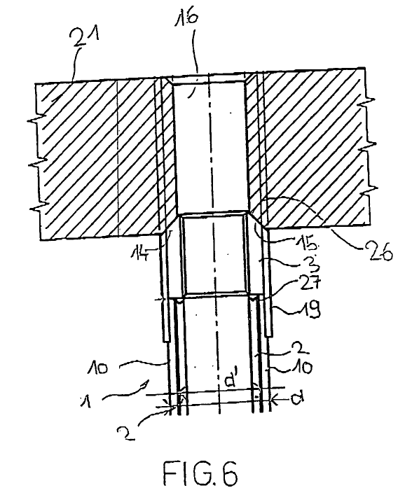

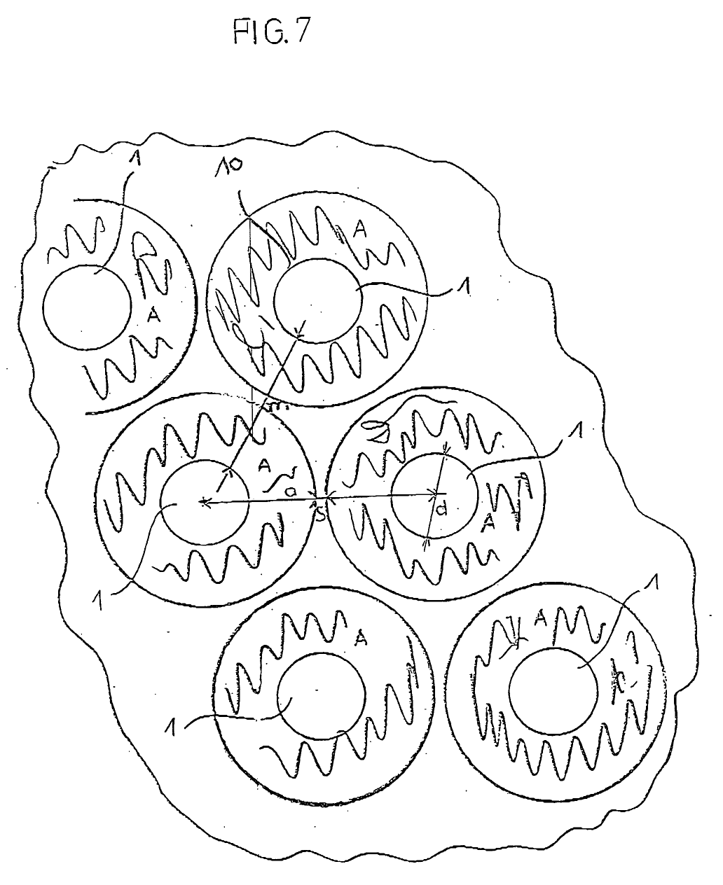

FIG. 6 shows an enlarged illustration of the top piece 3 with which the filter cartridge 1 is fixed in an opening 16 in the dividing plate 21. The top piece 3 has an annular bulge 27, onto which the supporting rods 2 are welded in a manner known per se (see, for example, EP 203 206). A sleeve 19 is arranged around the top piece 3 and covers the topmost part of the cartridge wall 10. At an upper end 14, the top piece 3 has a conical sealing surface 15. The conical sealing surface 15 is pressed against a corresponding sealing surface 26 which runs around the opening 16 in the perforated plate 21. The filter cartridge 1 is screwed firmly to the dividing plate 21 in a manner known per se.

The design of the filter cartridge 1 and its fixing to the dividing plate is otherwise carried out in a manner known per se, in particular for example in accordance with the design in EP 203 206. The wire 7 has a triangular cross section, in a manner known per se. The point of the triangle is oriented inwards and is connected to the supporting rods 2. The smooth outer surface of the wound wire 7 forms the outer side of the cartridge wall 10. With the exception of the reduction in the diameter d, the number and shape of the supporting rods 2, the dimensions and design of the cartridge wall 10 correspond substantially to the disclosure in EP 203 206.

FIG. 7 shows an enlarged illustration of a detail of the cross section through a filter vessel (see FIG. 4). Filter cartridges 1 are arranged in the manner of a honeycomb. In the course of the precoating with filter aid and the filtration, a precoat layer A of filter aid forms on the cartridge wall 10. Turbid materials are deposited on the precoat layer in the course of the filtration, so that the precoat layer A grows over the course of time on account of the turbid materials and on account of filter aid added to the unfiltrate. The filtration is continued until the filter layer has a maximum diameter 2a. In the exemplary embodiment according to the invention, the maximum diameter 2a is 70 mm. As a result, between the precoat layers A of two adjacent filter cartridges, given a spacing m of 72 mm, the result is a gap s of 2 mm. This gap is provided as a safety margin, in order that the precoat layers A of adjacent filter cartridges do not touch one another, which could lead to non-uniform pressure conditions and therefore to distortions of the cartridge.

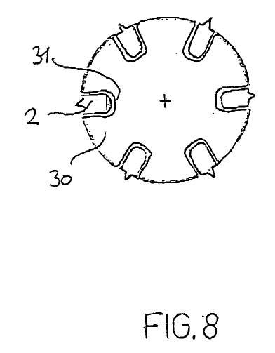

FIG. 8 shows in schematic form a mandrel 30 on which supporting rods 2 are fixed. In order to produce a cartridge wall 10 of a filter cartridge according to the invention, supporting rods 2 are fixed on this mandrel 30 in depressions 31. As the mandrel rotates, the wire (not shown in FIG. 8) is wound helically onto the supporting rods 2 in a manner known per se and welded to the latter. In order that the diameter of the filter cartridge can be reduced according to the invention, the supporting rods 22 (see also FIG. 3) have a rounded portion at their inner radial end 12. By virtue of the rounded portion, the inner ends of the supporting rods 2 are prevented from lying too close to one another in the case of small cartridge diameters.

What is claimed is:

1. A precoat filter cartridge having
a plurality of holding elements, such as supporting rods,
a top piece for fixing the cartridge to a dividing wall of a cartridge filter, which top piece is connected to one end of the supporting rods,
a terminating piece for dividing off a cartridge internal space with respect to an unfiltrate space,
a wire being wound helically onto the holding elements, so that a gap for the passage of liquid is formed between adjacent turns of the wire, the wire forming a cartridge wall as a substrate for a precoat filter layer,
the outer diameter of the cartridge being less than 30 mm.

2. The invention of claim 1, wherein said outer diameter is between 20 mm and 28 mm.

3. The invention of claim 1, wherein said outer diameter is about 25 mm.

4. A precoat filter cartridge according to claim 1, wherein the precoat filter cartridge has less than 8 supporting rods.

5. The invention of claim 1, wherein the precoat filter cartridge has 4 to 7 supporting rods.

6. The invention of claim 1, wherein the precoat filter cartridge has 6 supporting rods.

7. The invention of claim 1, wherein, on a side oriented radially inwards, the supporting rods have a cross-sectional taper.

8. The invention of claim 1, wherein, on a side oriented radially inwards, the supporting rods have a rounded portion.

9. The invention of claim 1, wherein the terminating piece tapers towards one end.

10. The invention of claim 1, wherein the top piece has a conical sealing surface at an end that can be brought into contact with the dividing wall.

11. A precoat cartridge filter having a filter vessel with a dividing wall, which divides the filter vessel into an unfiltrate space and into a filtrate space, and a number of precoat filter cartridges fixed to the dividing wall, in particular precoat filter cartridges according to claim 1, extending from the dividing wall into the unfiltrate space, wherein the product of cartridge diameter in mm and cartridge spacing in mm is between 1000 mm² and 2300 mm², per meter of filter cartridge length and per m² of cross-sectional area of the unfiltrate space.

12. The invention of claim 11, wherein said cartridge spacing is between 1500 mm² and 2000 mm², per meter of filter cartridge length and per m² of cross-sectional area of the unfiltrate space.

13. The invention of claim 11, wherein the total surface of the cartridge wall of all precoat filter cartridges is more than 10 m², per meter of filter cartridge length and per m² of cross-sectional area of the unfiltrate space.

14. The invention of claim 11, wherein the total surface of the cartridge wall of all precoat filter cartridges is more than 12 m², per meter of filter cartridge length and per m² of cross-sectional area of the unfiltrate space.

15. A method of using a filter cartridge according to claim 1 in a precoat filter according to claim 11.

16. A method of using a filter cartridge according to claim 1 to replace filter layers of a horizontal filter system thereby forming a cartridge filter.
